(19) United States
(12) Patent Application Publication
(10) Pub. No.: US 2009/0202964 A1
(43) Pub. Date: Aug. 13, 2009

(54) DRIVING SAFETY ASSESSMENT TOOL

(76) Inventor: Ely Simon, Bayside, NY (US)

Correspondence Address: Weingarten Schurgin Gagnebin & Lebovici, LLP;ABBO, Ten Post Office Square, BOSTON, MA, 02109, US

(21) Appl. No.: 11/817,543

(22) PCT Filed: Mar. 2, 2006
(86) PCT No.: PCT/IL06/00295

§ 371 Date: Jul. 7, 2008

Related U.S. Application Data
(60) Provisional application No. 60/657,701, filed on Mar. 3, 2005.

(51) Int. Cl. G09B 19/16

(52) U.S. Cl. 434/62

(57) ABSTRACT

A system and method for driving assessment includes multiple data sources, wherein results of tests from at least some of the multiple data sources are integrated. A driving assessment report including a driving recommendation is provided based on the integrated results. The multiple data sources may include cognitive tests, a background/medical data source, a visual/spatial skills data source, and a motor skills data source. A driving simulator may also be included.

### CROSS-REFERENCE TO RELATED APPLICATIONS

This application claims priority from U.S. Provisional Patent Application Ser. No. 60/657,701, filed on Mar. 3, 2005, entitled “Driving Safety Assessment Tool”, incorporated by reference herein in its entirety.

### FIELD OF THE INVENTION

The present invention relates to systems and methods for standardizing the measuring, evaluating and reporting of driving skills.

### BACKGROUND OF THE INVENTION

Driving is an activity which requires cognitive, visual and motor skills. It may be useful under certain circumstances to test a person's driving ability using a standardized testing tool.

Many different situations may warrant driving assessment. For example, driving assessment for the elderly may be requested by a doctor, family member, or the licensing authorities or police. Driving assessment may also be necessary for younger individuals, either following an illness or neurological impairment, or during initial testing for license approval. In some professions, an employer (such as, for example, a shipping company or a taxi company) may request evaluation and assessment of workers or potential workers.

The American Medical Association has provided rough guidelines for determining whether an individual has suitable ability to drive. Termed the Assessment for Driving Related Skills (ADReS), these guidelines include testing of vision (including acuity and visual fields), motor skills (including muscle strength and endurance, range of motion and proprioception) and cognitive function (including memory, attention, executive function and visual perception/visual-spatial skills). Although specific tests are recommended, scores are subjective and may be inaccurate due to patient/physician interaction. Also, the AMA does not provide a specific method of combining the resulting scores or presenting meaningful results. The AMA also does not provide guidelines about which particular tests may be relevant for particular individuals, or which results or outcomes should be used in a final determination of a score. Moreover, the recommended cognitive tests are paper based tests, which are prone to biases related to differences in administration techniques, scoring, and interpretation of results. Further, the recommended cognitive tests are not accessible for most patient care settings, as they require the skills of a highly trained psychologist or similarly trained professional.

### SUMMARY OF THE INVENTION

According to one aspect of the invention, there is provided a computerized system for driving assessment. The system includes at least one cognitive test for testing at least one cognitive domain of a subject, the test providing cognitive data for the cognitive domain, at least one additional data source providing additional data, a processor configured to integrate the cognitive data and the additional data, and a reporting module in communication with the processor and configured to provide a driving recommendation based on the integrated data.

According to another aspect of the invention, there is provided a method of integrating results from various data sources. The method includes comparing first test results to a first test fail threshold and a first test pass threshold, designating the first test results as pass, fail, or inconclusive based on the comparison, comparing second test results to a second test fail threshold and a second test pass threshold, designating the second test results as pass, fail, or inconclusive based on the comparison, determining an overall number of passes, an overall number of fails and an overall number of inconclusive designations, integrating the overall numbers into a final score, and reporting a driving recommendation based on the integrated score, wherein the comparing, designating, reporting and integrating are done using a processor.

According to yet another aspect of the invention, there is provided a method of assessing driving skills of a subject. The method includes presenting stimuli for a cognitive test for measuring a cognitive domain, collecting responses to the stimuli, calculating an outcome measure based on the responses, collecting additional data from an additional data source, and calculating a unified score based on the outcome measure and the additional data source.

According to further features in embodiments of the invention, the additional data source may include multiple additional data sources, which may be selected from the group consisting of a background/medical data source, a motor skills data source, and a visual/spatial skills data source. The background/medical data source may include, for example, a questionnaire, a driving record, and/or a medical record. The motor skills data source may include, for example, a range of motion test, and/or a muscle strength testing system. The visual/spatial skills data source may include, for example, a visual acuity test and/or a visual fields test. The cognitive test may include multiple cognitive tests, and may include, for example, a test for information processing, a test for executive function, a test for attention, a test for visual/spatial skills, and a test for memory. The driving recommendation may be a recommendation that it is unsafe to drive, a recommendation that it is safe to drive, a recommendation that it is safe to drive only in the daytime, a recommendation that it is safe to drive only after a road test, a recommendation that it is safe to drive only on familiar roads, and a recommendation that it is safe to drive only with another individual in the car.

In yet further features, the integrated data includes an index score. The integrated data may include a composite score. The processor may include selectors, including a domain selector for selecting a cognitive domain and/or a test selector for selecting a cognitive test. The reporting module may include summaries of the cognitive data and the additional data, and a score for the integrated data, which may be depicted in graphical format.

According to further features, the comparing of first and second test results may include comparing cognitive test results to one or more of either background/medical data source results, motor skills data source results and visual/spatial skills data source results.

According to yet additional features, the unified score may in some embodiment be an index score or a composite score. An index score could be a combination of an outcome measure of a cognitive test and additional data, wherein the cognitive test and the additional data source are for measurement of the same cognitive domain. The index score may also be a combination of outcome measures from a particular test or from multiple tests in a particular cognitive domain. The composite score may be a combined score of an index score and an outcome measure, from two index scores, or from outcome measures and additional data directly.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. In case of conflict, the patent specification, including definitions, will control. In addition, the materials, methods, and examples are illustrative only and not intended to be limiting.

### BRIEF DESCRIPTION OF THE DRAWINGS

The above and further advantages of the present invention may be better understood by referring to the following description in conjunction with the accompanying drawings in which:

FIG. 1 is a schematic illustration of a system in accordance with embodiments of the present invention;

FIG. 2 is a schematic illustration of a cognitive testing data source;

FIG. 3 is a schematic illustration of a method of using the cognitive testing data source of FIG. 2 to compute cognitive testing scores;

FIG. 4 is a block diagram illustration showing the steps of the method of FIG. 3;

FIG. 5 is a schematic illustration of one specific example of the multi-layered collection of data generally depicted in the schematic illustration of FIG. 2;

FIG. 6 is a flow chart diagram illustration of the steps of a test in accordance with one embodiment of the present invention;

FIG. 7 is a pictorial sample illustration of a three-dimensional picture shown in the 3-D spatial orientation test in accordance with one embodiment of the present invention;

FIG. 8 is a flow chart diagram illustration of a method of providing a designation for a particular test based on the results of that test; and

FIG. 9 is a flow chart diagram illustration of a method of integrating results from multiple tests from some or all of the data sources of the present invention, in accordance with one embodiment.

It will be appreciated that for simplicity and clarity of illustration, elements shown in the drawings have not necessarily been drawn accurately or to scale. For example, the dimensions of some of the elements may be exaggerated relative to other elements for clarity or several physical components may be included in one functional block or element. Further, where considered appropriate, reference numerals may be repeated among the drawings to indicate corresponding or analogous elements. Moreover, some of the blocks depicted in the drawings may be combined into a single function.

### DETAILED DESCRIPTION OF THE INVENTION

In the following detailed description, numerous specific details are set forth in order to provide a thorough understanding of the present invention. It will be understood by those of ordinary skill in the art that the present invention may be practiced without these specific details. In other instances, well-known methods, procedures, components and structures may not have been described in detail so as not to obscure the present invention.

The present invention is directed to a standardized driving safety assessment tool for determining driving ability based on cognitive, motor and visual ability, as well as personal and medical information and driving records.

A system and method for screening and evaluation of neurological function is described in U.S. Patent Publication Number 2005-0142524 to Simon et al., (referred to hereinafter as the '524 Publication) and is incorporated by reference herein in its entirety. In Simon et al., a system is disclosed which is designed to provide an initial view of cognitive function to a physician, prior to or concurrent with a clinical examination. The present application uses some of the components of the system disclosed in Simon et al., but specifically tailored for assessment of driving ability.

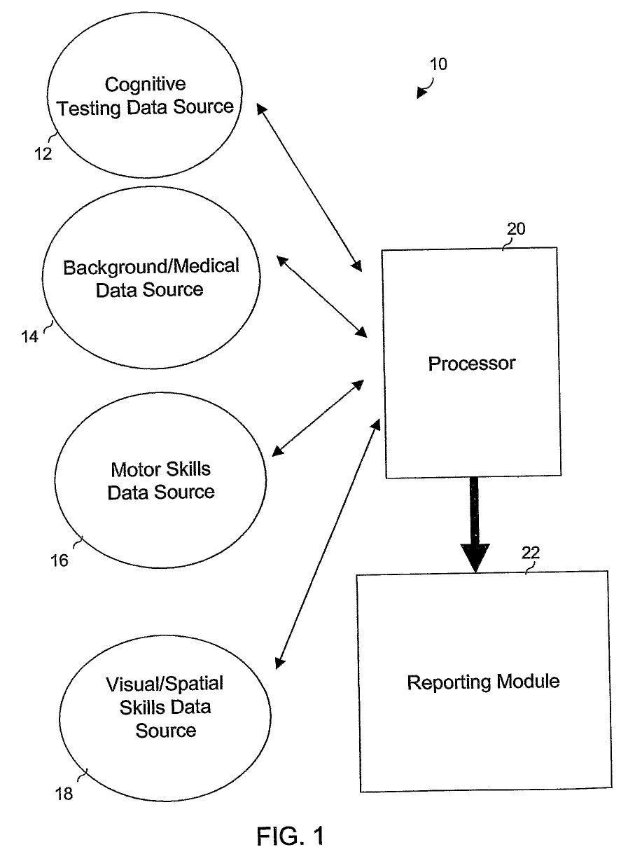

Reference is now made to FIG. 1, which is a schematic illustration of a system 10 in accordance with embodiments of the present invention. System 10 includes multiple data sources, including a cognitive testing data source 12, a background/medical data source 14, a motor skills data source 16, and a visual/spatial skills data source 18. System 10 further includes a data processor 20 for processing data received from some or all of data sources 12, 14, 16, and 18, and a reporting module 22 for presenting processed data. System 10 is an interactive system, wherein data from any one of data sources 12, 14, 16, and 18 may be used by processor 20 to determine output of the other data sources. For example, information received by processor 20 from visual/spatial skills data source 18 may be used to determine what data should be collected from cognitive testing data source 16. Alternatively, a combination of collected data from some of data sources 12, 14, 16 and 18 may be used by processor 20 to determine output of the other data sources. Additionally, information received from any or all of data sources 12, 14, 16, and 18, or from any combination thereof, may be selectively or non-selectively combined in various ways by processor 20, and sent in various formats to reporting module 22. For the purposes of the present invention, “tests” refers generally to any evaluation by any of data sources 12, 14, 16, 18.

### Cognitive Testing Data Source

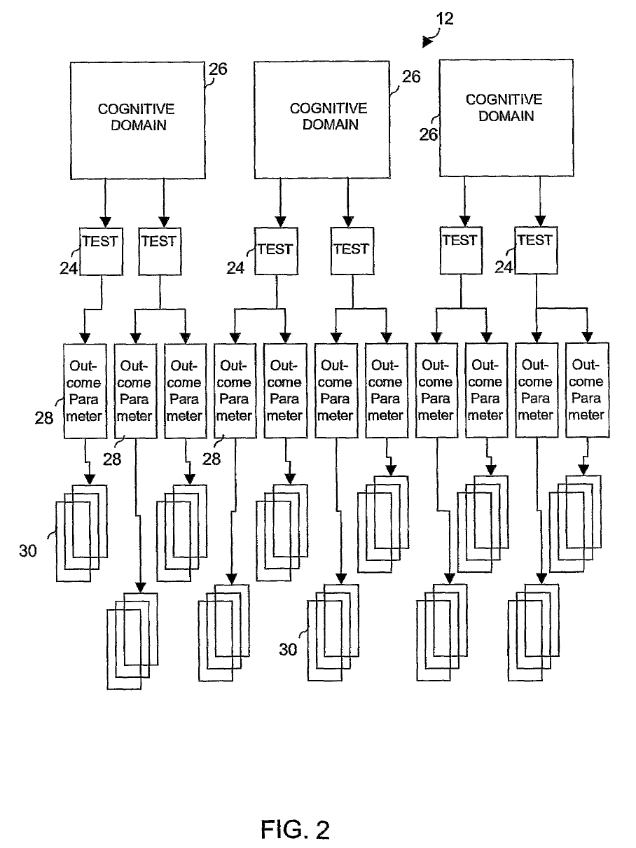

Reference is now made to FIG. 2, which is a schematic illustration of cognitive testing data source 12. As shown in FIG. 2, cognitive testing data source 12 is a system which may include one or more tests 24 for one or more cognitive domains 26. Cognitive domains 26 may include, for example, information processing, executive function, visual/spatial skills, memory, language skills, motor planning, motor learning, emotional processing, useful visual fields, attention, or any other cognitive domain. Tests 24 for information processing may include, for example, a staged math test. Tests 24 for executive function may include, for example, a Stroop test, a Go/NoGo Inhibition Test, or a non-verbal IQ test. Tests 24 for visual/spatial skills may include, for example, a 3-D spatial orientation test. Tests 24 for memory may include, for example, a verbal memory test or a non-verbal memory test. Tests for motor planning or motor learning may include, for example, a finger tap test or a catch test. Each of these tests is described more fully in US Patent Publication Number 2004-0167380, (referred to hereinafter as the '380 Publication), incorporated by reference herein in its entirety. The tests 24 of the present invention, however, are not limited to the ones listed above or the ones described in the '380 Publication. It should be readily apparent that many different cognitive tests may be used and are still within the scope of the invention.

Each test 24 may have one or more measurable outcome parameters 28, and each outcome parameter 28 has outcomes 30 obtained from user input in response to stimuli of tests 24. Multiple responses or outcomes 30 for each outcome parameter 28 may be collected, either sequentially, simultaneously, or over a period of time. Outcome parameters 28 may include, for example, response time, accuracy, performance level, learning curve, errors of commission, errors of omission, or any other relevant parameters. Thus, as will be described in greater detail hereinbelow, cognitive testing data source 12 may provide many layers of testing and data collection options.

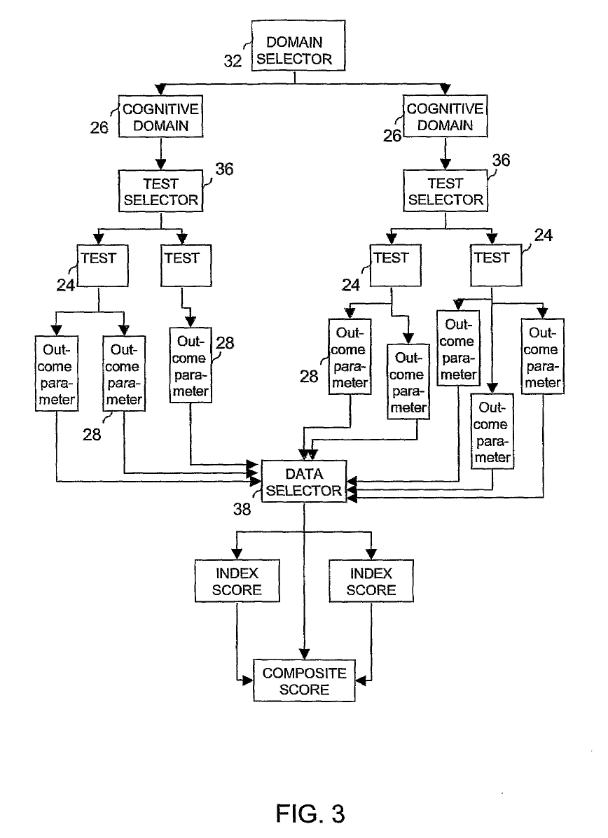

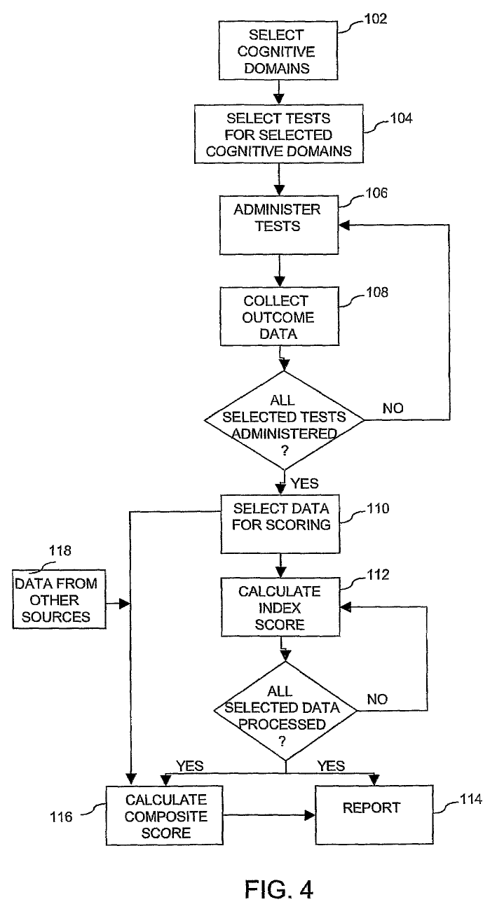

Reference is now made to FIGS. 3 and 4, which are schematic and block diagram illustrations, respectively, of a method of using cognitive testing data source 12 to compute cognitive testing scores for selected cognitive domains, for overall cognitive performance, and for overall driving ability. First, a domain selector 32 selects (step 102) cognitive domains 26 appropriate for the specific battery of tests. In one embodiment, domain selector 32 is an automated selector and may be part of processor 20 of system 10 depicted in FIG. 1. Selection of cognitive domains may be based on previously collected data from the same individual, background or medical data from background/medical data source 14, motor skills data from motor skills data source 16, visual/spatial skills data from visual/spatial skills data source 18, known and/or published data in the field of neuropsychology or other related fields, known and/or published data regarding testing of driving skills, or input from a clinician or testing administrator. Alternatively, domain selector 32 may be a clinician or testing administrator, manually selecting specific cognitive domains 26 based on a clinical examination, patient status, or other information as listed above with respect to automated selection. This may be done, for example, by providing pre-packaged batteries focusing on specific domains. Alternatively, a “domain selection wizard” may help the clinician select the appropriate domains, based on interactive questions and responses. These can lead to a customized battery for a particular individual. Additionally, domain selection may be done after administration of some or all of the other elements of system 10, either automatically or manually based on initial results.

For each cognitive domain 26, a test selector 36 selects (step 104) tests 24. In one embodiment, test selector 36 is the same as domain selector 32. In another embodiment, test selector 36 is different from domain selector 32. For example, domain selector 32 may be a testing administrator while test selector 36 is an automated selector in processor 20. Alternatively, both domain selector 32 and test selector 36 may be automated selectors in processor 20, but may be comprised of different components within processor 20. Selection of tests for cognitive domains may be based on previously collected data from the same individual, background or medical data from background/medical data source 14, motor skills data from motor skills data source 16, visual/spatial skills data from visual/spatial skills data source 18, known and/or published data in the field of neuropsychology or other related fields, known and/or published data regarding testing of driving skills, input from a clinician or testing administrator, clinical examination results, patient status, or any other known information. Processor 20 of system 10 then administers (step 106) a test 24 selected by test selector 36. Processor 20 collects (step 108) outcome data from each of the outcome parameters of the selected test. The steps of administering a selected test and collecting outcome data from outcome parameters of the selected test are repeated until all selected tests 24 for all selected cognitive domains 26 have been administered, and data has been collected from the selected and administered tests 24.

A data selector 38 may then select (step 110) data from all of the collected outcomes for processing. In one embodiment, data selector 36 is the same as domain selector 32 and/or test selector 36. In another embodiment, data selector 38 is different from either or both of domain selector 32 and test selector 36. For example, domain selector 32 may be a testing administrator while data selector 38 is an automated selector in processor 20. Alternatively, domain selector 32, test selector 36 and data selector 38 may be automated selectors in processor 20, but may be comprised of different components within processor 20. In some embodiments, data selector 38 is a pre-programmed selector, wherein for particular domains or tests, specific outcome measures will always be included in the calculation. Selection of data for processing may be based on previously collected data from the same individual, background or medical data from background/medical data source 14, motor skills data from motor skills data source 16, visual/spatial skills data from visual/spatial skills data source 18, known and/or published data in the field of neuropsychology or other related fields, known and/or published data regarding testing of driving skills, input from a clinician or testing administrator, clinical examination results, patient status, or any other known information. In one embodiment, data selector 38 selects all of the collected data. In another embodiment, data selector 38 selects a portion of the collected data.

Processor 20 then calculates (step 112) index scores for the selected data and/or calculates (step 116) composite scores for the selected data. In one embodiment, index scores are calculated first. Index scores are scores which reflect a performance score for a particular skill or for a particular cognitive domain. Thus, index scores can be calculated for particular tests 24 by algorithmically combining outcomes from outcome parameters 28 of the test 24 into a unified score. This algorithmic combination may be linear, non-linear, or any type of arithmetic combination of scores. For example, an average or a weighted average of outcome parameters may be calculated. Alternatively, index scores can be calculated for particular cognitive domains by algorithmically combining outcomes from selected outcome parameters 28 within the cognitive domain 26. This algorithmic combination may be linear, non-linear, or any type of arithmetic combination of scores. For example, an average or a weighted average of outcome parameters may be calculated. The calculation of index scores continues until all selected data has been processed. At this point, the calculated index scores are either sent (step 114) directly to reporting module 22, or alternatively, processor 20 calculates (step 116) a composite score, and sends (step 114) the composite score to reporting module 22. In one embodiment, there is no index score calculation at all, and processor uses the selected data to directly calculate (step 116) a composite score. In some embodiments, the composite score further includes input from data which is collected (step 118) from other data sources, such as, for example, background/medical data source 14, motor skills data source 16, and/or visual/spatial skills data source 18.

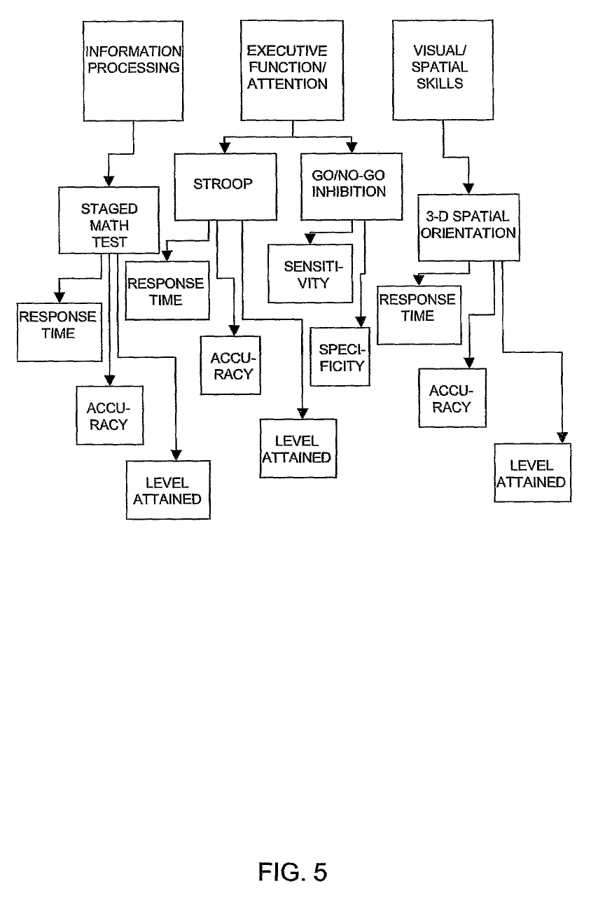

Reference is now made to FIG. 5, which is a schematic illustration of one specific example of the multi-layered collection of data generally depicted in the schematic illustration of FIG. 2. In the embodiment shown in FIG. 5, the cognitive domains of information processing, executive function/attention, and visual/spatial skills are selected. A staged math test is used for information processing; a stroop test and a Go/NoGo Inhibition test is used for executive function/attention; and a 3-D spatial orientation test is used for visual/spatial skills. Specific details about each of these tests are described in the '380 Publication. As disclosed in the '380 Publication, each cognitive test includes several levels, practice sessions, layers of data, quality assurance, and many other features.

### Staged Math Test

As described in the '380 Publication, the staged math test is designed to assess a subject's ability to process information, testing both reaction time and accuracy. Additionally, this test evaluates math ability, attention, and mental flexibility, while controlling for motor ability.

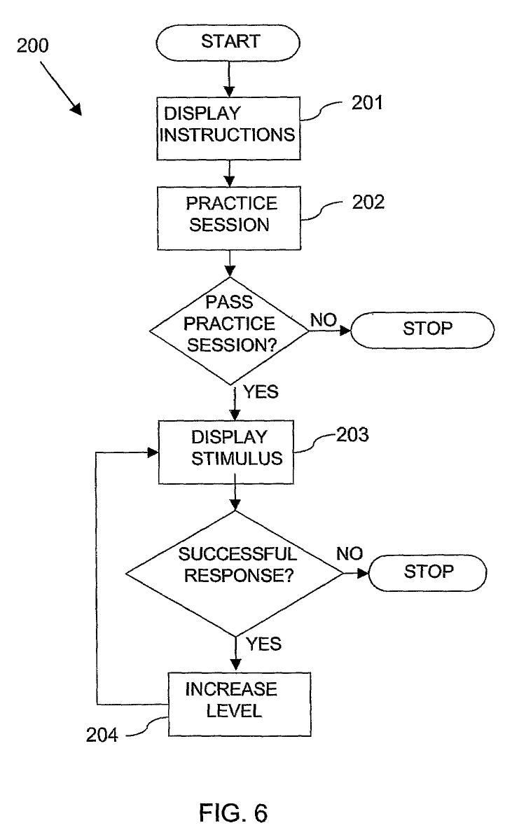

Reference is now made to FIG. 6, which is a flow chart diagram illustration of the steps of a test 200. In a preferred embodiment, the test consists of at least three basic levels of difficulty, each of which is subdivided into subsection levels of speed. The test begins with a display of instructions (step 201) and a practice session (step 202). The first subsection level of the first level is a practice session, to familiarize the subject with the appropriate buttons to press when a particular number is given. For example, the subject is told that if the number is 4 or less, he/she should press the left mouse button. If the number is higher than 4, he/she should press the right mouse button. The instructions continue with more detailed explanation, explaining that if the number is 4, the subject should press the left mouse button and if the number is 5, the subject should press the right mouse button. It should be readily apparent that any number can be used, and as such, the description herein is by way of example only.

A number is then shown on the screen. If the subject presses the correct mouse button, the system responds positively to let the user know that the correct method is being used. If the user presses an incorrect mouse button, the system provides feedback explaining the rules again. This level continues for a predetermined number of trials, after which the system evaluates performance. If, for example, 4 out of 5 answers are correct, the system moves on to the next level. If less than that number is correct, the practice level is repeated, and then reevaluated. If after a specified number of practice sessions the performance level is still less than a cutoff percentage (for example, 75% or 80%), the test is terminated.

The test is then performed at various levels, in which a stimulus is displayed (step 203), responses are evaluated, and the test is either terminated or the level is increased (step 204). The next three subsection levels perform the same quiz as the trial session, but at increasing speeds and without feedback to the subject. The speed of testing is increased as the levels increase by decreasing the length of time that the stimulus is provided. In all three subsection levels, the is duration between stimuli remains the same.

The next level of testing involves solving an arithmetic problem. The subject is told to solve the problem as quickly as possible, and to press the appropriate mouse button based on the answer to the arithmetic problem. For the example described above, if the answer to the problem is 4 or less, the subject must press the left mouse button, while if the answer to the problem is greater than 4, the subject must press the right mouse button. The arithmetic problem is a simple addition or subtraction of single digits. As before, each set of stimuli is shown for a certain amount of time at the first subsection level and subsequently decreased (thus increasing speed necessary reaction time) at each further level.

The third level of testing is similar to the second level, but with a more complicated arithmetic problem. For example, two operators and three digits may be used. After each level of testing, accuracy is evaluated. If accuracy is less than a predetermined percentage (for example, 70%) at any level, then that portion of the test is terminated. It may be readily understood that additional levels are possible, both in terms of difficulty of the arithmetic problem and in terms of speed of response.

It should be noted that the mathematical problems are design to be simple and relatively uniform in the dimension of complexity. The simplicity is required so that the test scores are not highly influenced by general mathematical ability. In one embodiment, the stimuli are also designed to be in large font, so that the test scores are not highly influenced by visual acuity. In addition, since each level also has various speeds, the test has an automatic control for motor ability.

The system collects data regarding the response times, accuracy and level reached, and calculates scores based on the collected data.

### Stroop Test

A Stroop test is a well-known test designed to test higher brain functioning. In this type of test, a subject is required to distinguish between two aspects of a stimulus. In the Stroop test described in the '380 Publication, the subject is shown words having the meaning of specific colors written in colors other than the ones indicated by the meaning of the words. For example, the word RED is written in blue. The subject is required to distinguish between the two aspects of the stimulus by selecting a colored box either according to the meaning of the word or according to the color the word is written in. The additional parameter of speed is measured simultaneously.

The first part of the test is a practice session. The system displays two colored boxes and asks the subject to select one of them, identifying it by color. Selection of the appropriate box may be accomplished by clicking the right or left mouse button, or by any other suitable method. The boxes remain visible until a selection is made. After responding, the system provides feedback if the incorrect answer was chosen. The practice session is repeated several times. If the performance is less than a predetermined percentage (for example, 75% or 80%), the practice session is repeated. If it is still less than the predetermined percentage after another trial, then the test may be terminated.

Once the practice session is completed, the system presents a random word written in a certain color. In addition, the system presents two boxes, one of which is the same color as the word. The subject is required to select the box corresponding to the color of the word and is not presented with feedback. This test is repeated several times. On the next level, the system presents the words “GREEN”, “BLUE” or “RED”, or another word representing a color. The word is presented in white font, and the system concurrently presents two boxes, one of which is colored corresponding to the word. The subject is required to select the box corresponding to the color related to the meaning of the word without receiving feedback. This test is repeated several times, preferably at least 2-3 times the number of samples as the first part. In this way, the subject gets used to this particular activity.

The next level is another practice session, in which the system presents a color word written in a color other than the one represented by the meaning of the word. The subject is instructed to respond to the color in which the word is written. Because it is a practice session, there is feedback. The test is repeated several times, and if the performance is not above a certain level, the test is terminated. If the subject is successful in choosing the color that the word is written in rather than the color that represents the meaning of the word, the next level is introduced.

The next level is the actual “Stroop” test, in which the system displays a color word written in a color other than the one represented by the word. The word is visible together with two options, one of which represents the color the word is written in. The subject is required to choose that option. This test is repeated numerous times (30, for example), and there is no feedback given. Level, accuracy and response time are all collected and analyzed.

### Go/NoGo Response Inhibition

As described in the '380 Publication, a Go/No Go Response Inhibition test is provided in accordance with one embodiment of the present invention. The purpose of the test is to evaluate concentration, attention span, and the ability to suppress inappropriate responses.

The first level is a practice session. The system displays a colored object, such as a box or some other shape. The object is a single color, preferably red, white, blue or green. It should be noted that by using a color as a stimulus, rather than a word such as is the case in prior art tests of this type, the test is simplified. This simplification allows for subjects on many different functional levels to be tested, and minimizes the effect of reading ability or vision. The subject is required to quickly select a mouse button for the presence of a particular color or not press the button for a different color. For example, if the object is blue, white or green, the subject should quickly press the button, and if the object is red, the subject should refrain from pressing the button. It should be readily apparent that any combination of colors may be used.

The first level of the test is a practice session, wherein the subject is asked to either react or withhold a reaction based on a stimulus. Each stimulus remains visible for a predetermined amount of time, and the subject is considered to be reactive if the response is made before the stimulus is withdrawn. In a preferred embodiment, the system presents two red objects and two different colored objects, one at a time, each for a specific amount of time (such as a few hundred milliseconds, for example). The subject is asked to quickly press any mouse button when any color other than red is displayed, and to not press any button when a red color is displayed. Feedback is provided in between each of the trials to allow the user to know whether he/she is performing correctly. If the subject has at least a certain percentage correct, he/she moves on to the next level. Otherwise, he/she is given one more chance at a practice round, after which the test continues or is terminated, depending on the subject's performance.

There is only one testing level for this particular embodiment, in which the stimuli are similar to the ones given in the practice session, but the subject is not provided with any feedback. Both sensitivity and specificity are calculated.

### 3-D Spatial Orientation Test

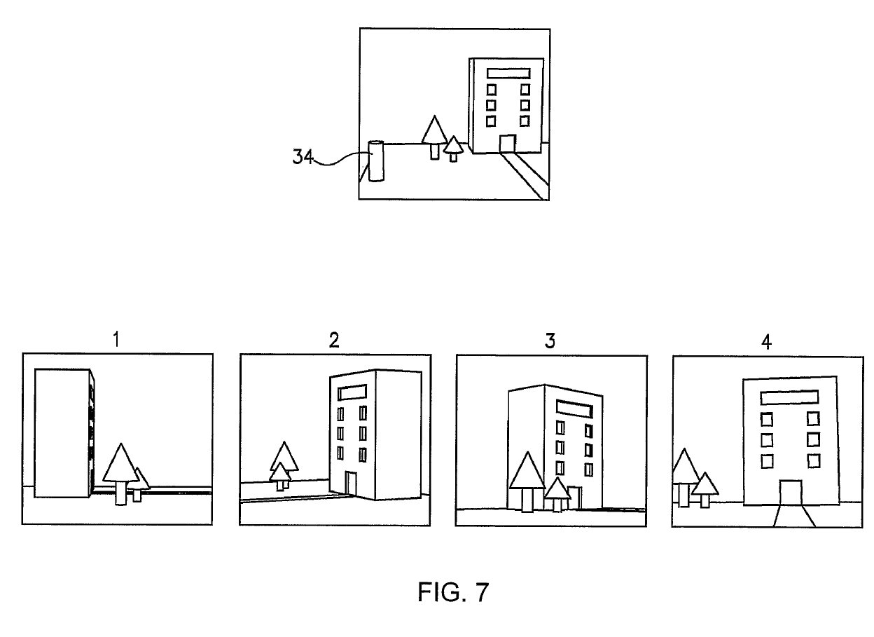

As described in the '380 Publication, a 3-D spatial orientation test is designed to assess spatial perception and mental rotation capabilities. FIG. 7 depicts a sample three-dimensional picture shown in the 3-D spatial orientation test. It should be readily apparent that the picture depicted in FIG. 7 is for exemplary purposes only, and that any picture or set of pictures may be used.

At the beginning of each test, a three-dimensional picture such as the one shown in FIG. 7 appears on a screen with a marker 34 located in variable places on the picture. The marker 34 is of a specified shape or color, for example, a blue line, a green diamond, a red pillar or any other suitable form. A set of pictures is shown on another part of the screen. Each of the pictures represents a potential view of the picture as seen from the position of marker 34. The subject is expected to choose the most correct view, based on the pictures shown on the screen. Neither the picture nor the marker is limited to the ones described and shown herein, but rather, may be any three-dimensional orientation of objects suitable for testing spatial orientation. It should be noted, however, that the choice of scene is predetermined based on simplicity and least likelihood of causing interference with the actual skills being tested.

The test may include several levels and as such, the basic format is shown FIG. 6. First, the system displays (step 201) a set of instructions. The instructions direct the subject to imagine standing at the place of the marker 34, and to visualize what view of the three-dimensional picture would be seen from that position. In a preferred embodiment, an example is displayed, followed by the correct answer for further edification. The instructions end with an explanation of how to choose the correct answer, for example, by pressing the correct number on the number pad of a keyboard.

The test begins (step 202) with a practice session. During the practice session, the choices remain on the screen until one of the displayed pictures is selected as a response, and once a selection is made, positive or negative feedback is provided to the subject. For the practice session, marker 34 is placed directly in front of the scene or in some other similarly easy to visualize location. Once a predetermined number of trials are successfully completed, the regular testing session is administered. A determination of whether or not the practice session was successfully completed is made based on the number of correct responses. If the practice session is not successful, additional pictures are shown. If the overall accuracy is less than a predetermined amount, the test is terminated. Otherwise, the test moves on to the next level. It should be readily apparent that the required number of correct responses can be varied.

Once the practice session is completed, the testing round begins. The system displays (step 203) a picture similar to the one displayed in the practice session. In a preferred embodiment, the marker 34 is placed in a slightly more difficult location, such as on one side or at varying distances. In one embodiment, a sample size of at least 10-20 pictures is collected. For all levels of the testing round, no feedback is given to the subject. The accuracy is then calculated. If the performance is acceptable based on predetermined criteria, the testing session moves (step 204) onto the next level.

A higher level tests relative spatial perception. A first picture is shown on one part of a screen, and four choices are shown on a different part of the screen, as in the other levels. However, although all four of the choices show pictures similar to the first one at various angles, only one of the four options actually has the same elements in the same relative locations. Thus, the subject is required to determine not only what the approximate view would be from the marker, but also which view is an accurate depiction of the original scene at a different angle. It should be readily apparent that any number of levels of increasing difficulty may be used.

The system collects data related to the responses, including timing, correctness and level of testing, and calculates scores based on the above parameters.

Once the tests are administered and data is collected, data selector 38 selects outcome parameters for data calculation. For example, data selector 38 may select response times from the staged math test and the stroop test, accuracy for all of the tests, and level for 3-D spatial orientation. As another example, data selector 38 may select all of the outcome parameters from all of the tests. Any combination may be selected, and the selection may either be pre-programmed, may depend on other collected data from the same individual or from published information, or may be manually selected.

It should be readily apparent that other batteries of tests for other cognitive domains may be used. For example, tests for verbal or non-verbal memory may be used for the memory domain, or cognitive tests which include a measure of motor skills may be included. For certain applications, the emphasis can be placed on one or two particular cognitive domains. In other embodiments, a comprehensive testing scheme may be administered, taking into account many cognitive domains.

All tests in the battery may provide a wide range of testing levels, practice sessions to eliminate the bottom portion of the learning curve, unbiased interaction between the patient and clinician, and a rich amount of data from which to calculate scores.

### Background/Medical Data Source

Background/medical data source 14 may include medical history of the individual to be tested (ie, official medical records), driving history of the individual (such as official driving records from a motor vehicle department), and/or one or multiple questionnaires. For example, a first questionnaire may include questions about the driving record of the individual and a second questionnaire may include questions about cognitive symptoms. The questionnaires may be completed by the individual, or by a person close to the individual, such as a family member, with or without input from the individual as well. In one embodiment, questionnaires are presented via the computer, and the answers to the posed questions are stored in a database. Alternatively, the questionnaires are presented on paper, and the answers are later entered into a computer. A questionnaire about driving record includes questions regarding driving history over the last few months, including number of moving violations, number of accidents and reporting of who was considered to be at fault, and other relevant questions. A cognitive questionnaire may include questions about cognitive health, performance, personal information and history, family history, medications, questions related to anxiety level and/or mood, questions related to activities of daily living (ADL)—including driving, shopping, ability to manage finances, household chores, and the like. Answers may be yes/no answers, or may be graded responses, such as rating on a scale of 1-10.

### Motor Skills Data Source

Motor skills are evaluated by known methods. For example, motor testing can be assessed using range of motion measuring devices and muscle strength testing systems. Such devices are known, and may include for example, the Lafayette Manual Muscle Tester (Lafayette Instrument, Indiana, USA), the MicroFet Digital Muscle Testers (Hoggan Health Industries, Utah, USA), the Jamar Hand Dynomometer [Range of motion: Cervical Range of Motion Instrument] (Jamar Technologies, Pennsylvania, USA), and others. In some embodiments, motor skills are evaluated using cognitive tests, similar to the ones described above or described in the '380 Publication. All response data and/or measured data is collected, and either sent to reporting module 22 or integrated into a composite score with other collected data.

### Visual/Spatial Skills Data Source

Visual fields testing is done using known methods. For example, visual acuity can be tested using a standard Snellen chart or the “E” chart. Visual fields (i.e. the ability to see clearly in the periphery) is measured by manual or computerized perimetry or by the Useful Field of View Test, as described in Owsley C. et al, Visual Processing Impairment and Risk of Motor Vehicle Crash Among Older Adults, JAMA, 1998; 279:14, 1083-1088, incorporated herein by reference in its entirety. In one embodiment, a visual field test is presented to the individual at the time of testing, and the results are entered (either automatically during testing or afterwards manually) into the computer. All response data and/or measured data is collected, and either sent to reporting module 22 or integrated into a composite score with other collected data.

An additional optional component of system 10 includes a driving simulator. A simulator which is configured similar to a driving video game can be used to collect data in response to more realistic driving scenarios, and may include a steering wheel and gas pedal, with roads (both city and highway), obstacles, and scenarios including the need for a quick response such as a quick turn or stop. Specific data can be collected, such as the number of accidents and near misses, the number of deviations from an instructed route, etc. The simulator may provide additional information such as nighttime driving scores, fast speed scores, and judgment scores, for example. An advantage of using a simulator is that it can provide one standardized routine, and results can be compared both among population samples and within an individual's own record over time. Data from such a stimulator can be included in the composite score or it can be presented separately. In one embodiment, the simulator is only used for subjects with borderline results. In another embodiment, the simulator is used for an individual who is undergoing cognitive rehabilitation to view progress over time.

### Data Processing

Responses and/or scores from some or all of data sources 12, 14, 16, 18 and from a driving simulator are collected and summarized, or are used to calculate more sophisticated scores such as index scores and/or composite scores. In one embodiment, decision points are included along the way, wherein a particular result or set of results gives a clear indication of danger if the individual were to drive. For example, if the individual's vision is deemed to be unsuitable for driving, that alone may be cause to prevent him or her from driving, and he/she may receive a failing score based on only one parameter. Many other “danger” points are possible, in each of the domains. Other examples may include a failing score on any one of the cognitive tests, a very poor driving history, or any other single indication of danger. In addition to individual decision points, a total score which reflects a combination of the different elements of the system is presented as well. Decisions regarding suitability may stem from one or several of the above elements, depending on the data, the individual, and the physician's requirements. The order of scoring may be interchangeable among each of the elements.

Index scores are generated for each cognitive domain based on the tests and/or results from other data sources. For example, an index score may be generated from a combination of data collected from outcomes related to motor skills (such as response time, for example) and from measurements of range of motion. Alternatively, an index score may be generated for a particular domain based only on cognitive test responses. The index score is an arithmetic combination of several selected normalized scores. This type of score is more robust than a single measure since it is less influenced by spurious performance on any individual test. For example, an executive function index score may be comprised of individual measures from a Stroop test and a Go/NoGo Inhibition test. Alternatively, an executive function index score may be comprised of individual measures from one test (such as a Stroop test) over several trials. An example of an algorithm for computing the index score, according to one preferred embodiment, is a linear combination of a specific set of measures. The selection of the member of the set of measures and the weighting of each member is based on the known statistical method of factor analysis. The resulting linear combination is then converted to an index score by calculating a weighted average.

Composite scores may be calculated based on data from several index scores and may further be combined with specific scores from the additional data sources (i.e., background/medical data source, motor skills data source, visual/spatial skills data source) to provide a comprehensive driving assessment score. In alternative embodiments, composite scores may be calculated based on a combination of one index score and specific scores from the additional data sources. In yet another embodiment, composite scores may be calculated from particularly selected normalized outcome measures, and may further be combined with data from the additional data sources.

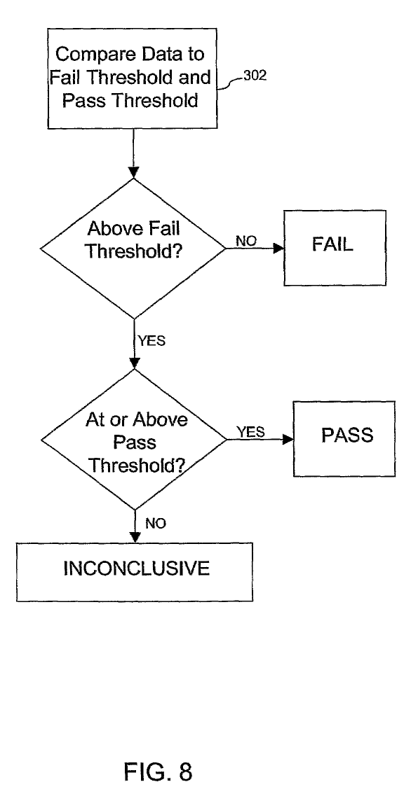

Reference is now made to FIG. 8, which is a flow chart diagram of a method of providing a designation for a particular test based on the results of that test. Each of data sources 12, 14, 16 and 18 may have an internal algorithm which allows for designations of “pass”, “fail” or “inconclusive”. It should be readily apparent that these terms are to be taken as representative of any similar terms to be used in the same context, such as, for example, “threshold reached”, “maybe pass”, “undetermined” or the like. Processor 20 first compares (step 302) data from a particular source to a pre-defined threshold value for passing and a pre-defined threshold value for failing. Alternatively, the pre-defined threshold values may each include several threshold values or ranges of values. If the data is not above the fail threshold value, the result for the particular test is “fail.” If the data is above the fail threshold value, it is compared to the pass threshold value. If it is above the pass threshold value, the result is “pass.” If it is not above the pass threshold value, the result is “inconclusive.” The data which is used for the comparison may be, for example, a final score for the particular test, after all data has been evaluated. This final score may be a single test score or an index score compiled from multiple tests, either within the same cognitive domain or from several cognitive domains. Alternatively, the data may be compared to the threshold values at the outcome measure level, wherein the comparison includes separate comparisons for each of the outcome measures for the specific test. In this case, it may be determined, for example, that if all outcome measures are below the failing threshold, or if a certain percentage of the outcome measures are below the failing threshold the result is “fail”. If all outcome measures are above the passing threshold, or if a certain percentage of the outcome measures are above the passing threshold, the result is “pass.” Otherwise, the result is “inconclusive.”

Examples of thresholds for particular tests include, for example, the following. For neck motion, it may be determined that motion greater than 60 degrees in both directions is designated as “pass”, motion of less than 30 degrees in either direction is “fail”, and any other amount in between is “inconclusive.” For motor strength for arms, designations may be made according to the MRC strength scale for manual testing. For example, less than ⅘ on the MRC strength scale may be designated as “fail”, more than ⅘ may be designated as “pass” and ⅘ may be designated as “inconclusive”. For visual acuity for distance, “pass” may be 20/20 vision, “fail” may be according to standard failing criteria for driving, and “inconclusive” may be anything in between. For a questionnaire on activities of daily living (ADL), designations may be made according to the Lawton ADL scale. For example, a total score of greater than 9 may be designated as “fail”, a total score of less than 4 may be designated as “pass”, and a total score of between 4 and 9 may be designated as “inconclusive.” For driving history, designations may be made according to the number of accidents or near misses within the last twelve months. For example, more than two accidents or near misses may be designated “fail”, no accidents or near misses may be designated “pass”, and 1 or 2 accidents or near misses may be designated “inconclusive.” Cognitive history may be designated according to past diagnoses. For example, a diagnosis of dementia may be designated “fail”, no cognitive complaints or abnormal findings may be designated “pass”, and a diagnosis of mild cognitive impairment (MCI) may be designated “inconclusive.”

For cognitive tests, there may various ranges of performance evaluation. Descriptions of such ranges are included in U.S. Patent Publication Number 2005-0187436, incorporated by reference herein in its entirety. Included in that description are ranges of “abnormal”, “normal”, “probable abnormal”, “probable normal”, etc. Thus, it may determined, for example, that for the executive function/attention cognitive domain, if both executive function and attention scores are in the abnormal range, results are designated as “fail” if neither executive function nor attention scores are in the abnormal range, results are designated as “pass”, and if one or the other of executive function or attention scores is in the abnormal range, results are designated as “inconclusive.” Likewise, for visual/spatial perception cognitive tests, results may be designated as “fail” if the visual/spatial index score is the abnormal range, “pass” if the index score is in the probable normal or normal range, and “inconclusive” if the index score is in the probable abnormal range. It should be apparent that many different designations may be defined.

It should be readily apparent that the actual numbers may vary, and that these examples are to be taken as illustrative only. Moreover, designations of fail, pass and inconclusive may be further expanded to include additional designations. For example, a numerical scale may be used, wherein results from each test are listed as a score from 1-5 or 1-10, wherein 1 is the worst result possible, 5 (or 10) is the best result possible, and the additional numbers indicating varying levels in between.

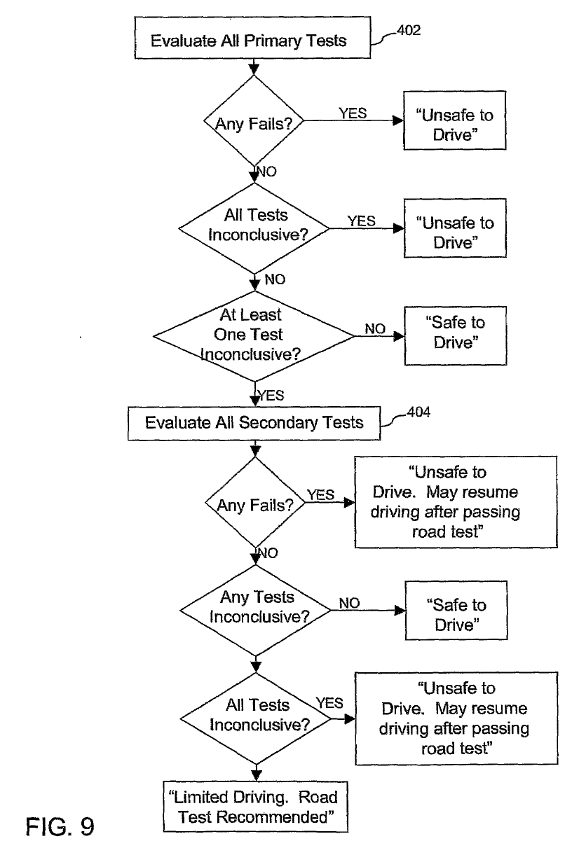

Reference is now made to FIG. 9, which is a flow chart diagram illustration of a method of integrating results from multiple tests from some or all of data sources 12, 14, 16, and 18, in accordance with one embodiment. First, tests are designated as primary tests or as secondary tests. This designation may be pre-determined for particular testing batteries, or may be tailored to an individual. For example, it may be determined that all cognitive tests are primary tests, visual tests are primary tests, and background/medical data are secondary tests. Alternatively, it may be determined that particular cognitive tests are primary tests, such as a stroop test and a 3-D spatial orientation test, for example, while other cognitive tests are secondary tests. First, processor evaluates (step 402) all primary tests. If any of the primary tests have a “fail” designation, the result is “unsafe to drive.” If all of the primary tests are “inconclusive”, the result is also “unsafe to drive.” If some of the tests are not “inconclusive”, the processor checks whether any of the tests are “inconclusive”. If not, that means that all primary tests have been passed and the result is “safe to drive”. If at least one test is inconclusive, processor 20 evaluates (step 404) all secondary tests. If any of the secondary tests have a “fail” designation, the result is “unsafe to drive. May resume driving after passing road test.” If none of the secondary tests have a “fail” designation, the processor checks whether any of the tests are “inconclusive”. If not, all secondary tests have been passed and the result is “Safe to Drive”. If at least one of the secondary tests is “inconclusive”, the processor checks whether all of them are “inconclusive”. If they are all “inconclusive”, the result is “unsafe to drive. May resume driving after passing road test.” If they are not all inconclusive, then some have been passed, and the result is “Limited driving. Road test recommended.”

It should be readily apparent that many other processes and results are possible. For example, there may be specific designations for results from vision tests, wherein inconclusive designations may result in “Drive only during the day.” Additional examples include “Drive with someone else in the car”, “Limit driving to local streets”, “Safe to drive, but reevaluate in half a year” or any other reasonable limitation or conclusion. Additionally, the criteria for specific results may be different than the ones depicted in FIG. 9 and described with respect thereto. For example, if certain primary tests are inconclusive, the result may be “unsafe to drive”, whereas if other primary tests are inconclusive, evaluation of secondary tests may be necessary. Alternatively, it may be decided that if any of the primary tests are inconclusive and any of the secondary tests are inconclusive, the result may be “unsafe to drive” or “limit driving” or the like. Any logical progression of integrating the tests from data sources 12, 14, 16, and/or 18 is envisioned and is within the scope of the present invention.

### Reporting Module

Index scores and/or composite scores may be graphed in two ways. A first graph shows the score as compared to the general population. The obtained score is shown on the graph within the normal range for the general population. The general population may either be a random sampling of people, or alternatively, may be a selected group based on age, education, socioeconomic level, or another factor deemed to be relevant. The second graph shows the score as compared to any previous results obtained from the same battery of tests on the same subject. This longitudinal comparison allows the clinician to immediately see whether there has been an improvement or degradation in performance for each particular index.

Alternatively, the score is calculated and compared to a normal population as well as a disease-specific population, immediately allowing the clinician to see what range the subject's performance fits into. Furthermore, several indices may be compared, so as to determine which index is the most significant, if any. Thus, the practitioner receives a complete picture of the performance of the individual as compared to previous tests as well as compared to the general population, and can immediately discern what type of medical intervention is indicated. It should also be noted that at different points during the test itself, it may be determined that a specific test is not appropriate, and the tests will then be switched for more appropriate ones. In those cases, only the relevant scores are used in the calculation.

Results or designations from the integration method depicted in FIG. 9 may be included in reporting module 22. For example, the report may include index scores, composite scores, graphs, summaries, and a conclusion such as: “Safe to Drive”, “Safe to drive during the day” or any other result.

Data are processed and compiled in a way which gives the clinician an overview of the results at a glance, while simultaneously including a large amount of information. Data are accumulated and compiled from the various tests within a testing battery, resulting in a composite score. A report showing results of individual parameters, as well as composite scores is then generated.

The report may be available within a few minutes over the internet or by any other communication means. The report includes a summary section and a detailed section. In the summary section, scores on cognitive tests are reported as normalized for age and educational level and are presented in graphical format, showing where the score fits into pre-defined ranges and sub-ranges of performance. It also includes graphical displays showing longitudinal tracking (scores over a period of time) for repeat testing. Also, the answers given to the questionnaire questions are listed, and scores for individual vision and motor tests are listed. Finally, it includes a word summary to interpret the testing results in terms of the likelihood of cognitive abnormality. The detailed section includes further details regarding the orientation and scoring. For example, it includes results for computer orientation for mouse and keyboard use, word reading, picture identification, and color discrimination. Scores are also broken down into raw and normalized scores for each repetition. Thus, a clinician is able to either quickly peruse the summary section or has the option of looking at specific details regarding the scores and breakdown. Each of these sections can also be independently provided. The report further provides a final impression and recommendations. Additionally, the report may include specific recommendations or limitations such as informing the user that the individual should not drive at night or in certain conditions, such as wet roads.

A system such as the one described herein may be useful for institutions outside of the medical community as well. For example, a motor vehicle department can use a system for determination of whether to grant a driver's license. It may be useful as an additional testing component, aside from the standard vision test. Driver's education courses might also find such a system useful in testing the participants and awarding a score prior to the regular driving test. Companies which employ drivers (such as taxi companies, limousine services, bus companies, etc.) can use a system to test a candidate for the job, and even to test for daily alertness and/or intoxication. Police officers can have a computerized system in their cars to test for intoxication on the road. In some of these scenarios, the system may have to be modified to fit the requirements, but the basic idea of including a cognitive testing battery and integrating it with other tests and questionnaires remains. It should be readily apparent that many modifications and additions are possible, all of which fall within the scope of the present invention.

While certain features of the present invention have been illustrated and described herein, many modifications, substitutions, changes, and equivalents may occur to those of ordinary skill in the art. It is, therefore, to be understood that the appended claims are intended to cover all such modifications and changes as fall within the true spirit of the present invention.

We claim:

1. A computerized system for driving assessment, the system comprising:
a cognitive testing data source, including at least one cognitive test for testing at least one cognitive domain of a subject, said at least one cognitive test providing cognitive data for said at least one cognitive domain;
at least one additional data source, said at least one additional data source providing additional data;
a processor, said processor configured to integrate said cognitive data and said additional data; and
a reporting module, said reporting module in communication with said processor and configured to provide a driving recommendation based on said integrated data.

2. The system of claim 1, wherein said at least one additional data source includes multiple additional data sources.

3. The system of claim 1, wherein said at least one additional data source is selected from the group consisting of: a background/medical data source, a motor skills data source, and a visual/spatial skills data source.

4. The system of claim 3, wherein said background/medical data source includes at least one of: a questionnaire, a driving record, and a medical record.

5. The system of claim 3, wherein said motor skills data source includes at least one of: a range of motion test, and a muscle strength testing system.

6. The system of claim 3, wherein said visual/spatial skills data source includes at least one of: a visual acuity test and a visual fields test.

7. The system of claim 1, wherein said at least one cognitive test comprises multiple cognitive tests.

8. The system of claim 1, wherein said at least one cognitive test is selected from the group consisting of: at least one test for information processing, at least one test for executive function, at least one test for attention, at least one test for visual/spatial skills, and at least one test for memory.

9. The system of claim 1, wherein said integrated data comprises an index score.

10. The system of claim 1, wherein said integrated data comprises a composite score for overall driving assessment.

11. The system of claim 1, wherein said processor comprises a domain selector, said domain selector configured to select said at least one cognitive domain for providing said cognitive data.

12. The system of claim 1, wherein said processor comprises a test selector, said test selector configured to select said at least one cognitive test for providing said cognitive data.

13. The system of claim 1, wherein said reporting module further comprises summaries of said cognitive data and said additional data and a score for said integrated data.

14. The system of claim 13, wherein said score for said integrated data is depicted in graphical format.

15. The system of claim 1, wherein said driving recommendation is selected from the group consisting of: a recommendation that it is unsafe to drive, a recommendation that it is safe to drive, a recommendation that it is safe to drive only in the daytime, a recommendation that it is safe to drive only after a road test, a recommendation that it is safe to drive only on familiar roads, and a recommendation that it is safe to drive only with another individual in the car.

16. A method of integrating results from various data sources, the method comprising:
comparing first test results to a first test fail threshold and a first test pass threshold;
designating said first test results as pass, fail, or inconclusive based on said comparison;
comparing second test results to a second test fail threshold and a second test pass threshold;
designating said second test results as pass, fail, or inconclusive based on said comparison;
determining an overall number of passes, an overall number of fails and an overall number of inconclusive designations;
integrating said overall numbers into a final score; and
reporting a driving recommendation based on said integrated score, wherein said comparing, designating, reporting and integrating are done using a processor.

17. The method of claim 16, wherein said comparing first test results comprises comparing cognitive test results, and wherein said comparing second test results comprises comparing vision test results.

18. The method of claim 16, wherein said comparing first test results comprises comparing cognitive test results, and wherein said comparing second test results comprises comparing background/medical data results.

19. The method of claim 16, wherein said comparing first test results comprises comparing cognitive test results, and wherein said comparing second test results comprises comparing motor data results.

20. The method of claim 16, wherein said comparing first test results comprises comparing cognitive test results, and wherein said comparing second test results comprises comparing driving simulator data results.

21. A method of assessing driving skills of a subject, the method comprising:
presenting stimuli for a cognitive test, said cognitive test for measuring a cognitive domain;
collecting responses to said stimuli;
calculating an outcome measure based on said responses;
collecting additional data from an additional data source; and
calculating a unified score based on said outcome measure and said additional data source.

22. The method of claim 21, wherein said collecting additional data comprises collecting data from a motor skills data source.

23. The method of claim 21, wherein said collecting additional data comprises collecting data from a background/medical data source.

24. The method of claim 21, wherein said collecting additional data comprises collecting data from a visual/spatial skills data source.

25. The method of claim 21, wherein said calculating a unified score includes calculating an index score, said index score comprising a combined score of said outcome measure and said additional data, wherein said cognitive test and said additional data source are for measurement of the same cognitive domain.

26. The method of claim 22, wherein said calculating an outcome measure comprises calculating multiple outcome measures, and wherein said calculating a unified score further comprises calculating a composite score, said composite score comprising a combined score of said index score and an additional outcome measure from said multiple outcome measures.

27. The method of claim 22, wherein said calculating an outcome measure comprises calculating multiple outcome measures, and wherein said calculating a unified score includes calculating an additional index score, said additional index score comprising a combined score from said multiple outcome measures.

28. The method of claim 21, wherein said calculating a unified score includes calculating a composite score, said composite score comprising a combined score of said index score and said additional index score.

29. The method of claim 21, wherein said calculating an outcome measure comprises calculating multiple outcome measures, the method further comprising combining said calculated multiple outcome measures into an index score, and wherein said calculating a unified score comprises combining said index score and said additional data into a composite score.

30. The method of claim 21, wherein said calculating an outcome measure comprises calculating multiple outcome measures, and wherein said calculating a unified score further comprises calculating a composite score, said composite score comprising a combined score of selected outcome measures and said additional data.
